(19) United States
(12) Patent Application Publication
(10) Pub. No.: US 2011/0052775 A1
(43) Pub. Date: Mar. 3, 2011

(54) Use of Thiazoline Compounds in Flavor Applications

(76) Inventors: David O. Agyemang, East Brunswick, NJ (US); Kathryn A. Bardsley, Howell, NJ (US); Linda Psota-Kelty, Tinton Falls, NJ (US); Laurence Trinnaman, Montvale, NJ (US)

(21) Appl. No.: 12/551,909

(22) Filed: Sep. 1, 2009

(51) Int. Cl. A23L 1/226; A23L 1/314; A23L 1/39; A23L 2/56; C12C 5/02; A23L 1/20; A23C 9/00; A23G 3/00; A23L 1/212; A23L 1/10; A23C 9/123

(52) U.S. Cl. 426/535; 426/583; 426/641; 426/590

(57) ABSTRACT

The invention is directed to a method for improving, enhancing or modifying the foodstuff through the addition of an effective amount of the following compound

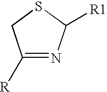

wherein R and R1 may be selected from hydrogen or a C₁ to C₅ alkyl group.

### FIELD OF THE INVENTION

The present invention relates to thiazoline compounds and the incorporation and use of the new chemical entities as flavor and fragrance chemicals.

### BACKGROUND OF INVENTION

There is an ongoing need in the flavor and fragrance industry to provide new chemicals to give flavorists and perfumers the ability to create new flavor accords and fragrances products.

In searching for new naturally-occurring flavor compounds, toasted sesame seed oil was analyzed and new, flavorful thiazoline compounds were found. These compounds can be used by flavorists in a wide variety of flavors.

### SUMMARY OF THE INVENTION

One embodiment of the invention is directed to a method for improving, enhancing or modifying a foodstuff through the addition of an effective amount of Formula I

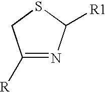

wherein R and R1 may be selected from hydrogen or a C₁ to C₅ alkyl group.

A preferred embodiment of the invention is directed to a method for improving, enhancing or modifying a foodstuff through the addition of an effective amount of Structure I

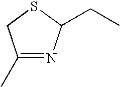

Another preferred embodiment of the invention is directed to a method for improving, enhancing or modifying a foodstuff through the addition of an effective amount of Structure II

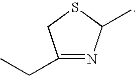

### DETAILED DESCRIPTION OF THE INVENTION

One embodiment of the invention is directed to a method for improving, enhancing or modifying a foodstuff through the addition of an effective amount of Formula I

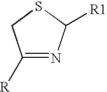

wherein R and R1 may be selected from hydrogen or a C₁ to C₅ alkyl group.

The term “foodstuff” as used herein includes both solid and liquid ingestible materials for man or animals, which materials usually do, but need not, have nutritional value. Thus, foodstuffs include meats, gravies, soups, convenience foods, malt, alcoholic and other beverages including soft drinks and soda, soy-containing products, milk and dairy products including yogurt and ice cream, herbs including basil, dill weed, parsley, oregano, marjoram, sage, thyme, rosemary, mint, cilantro, tarragon, chervil, seafood, including fish, crustaceans, mollusks and the like, candies, vegetables, cereals, snacks, dog and cat foods, other veterinary products and the like.

Formula I may also be used in savory food applications. Examples of preferred foodstuff include soups, gravies, meat dishes, snacks, marinades, and sauces.

In a preferred embodiment of the invention, Structure I and Structure II may be used to improve, enhance or modify a foodstuff.

According to the present invention, Structure I is known by one skilled in the art as 2-Ethyl-4-Methyl-3-Thiazoline and Structure II is known as 4-ethyl-2-methyl-3-thiazoline.

Structure I is described as possessing tropical fruit, catty, peach and berry flavor notes.

When the compounds of this invention are used in a flavoring composition, they can be combined with conventional flavoring materials or adjuvant. Such co-ingredients or flavor adjuvant are well known in the art for such use and have been extensively described in the literature. Requirements of such adjuvant materials are that they are organoleptically compatible with the Structures I and II and that they are ingestible acceptable and thus non-toxic or otherwise non-deleterious. Apart from these requirements, conventional materials can be used and broadly include other flavor materials, vehicles, stabilizers, thickeners, surface active agents, conditioners and flavor intensifiers.

Such conventional flavoring materials include saturated fatty acids, unsaturated fatty acids and amino acids; alcohols including primary and secondary alcohols, esters, carbonyl compounds including aldehydes and ketones; lactones; other cyclic organic materials including aryl compounds, alicyclic compounds, heterocyclics such as furans, pyridines, pyrazines and the like; sulfur-containing compounds including thiols, sulfides, disulfides and the like; proteins; lipids, carbohydrates; so-called flavor potentiators such as monosodium glutamate; magnesium glutamate, calcium glutamate, guanylates and inosinates; natural flavoring materials such as cocoa, vanilla and caramel; essential oils and extracts such as anise oil, clove oil and the like and artificial flavoring materials such as vanillin, ethyl vanillin and the like.

Specific preferred flavor adjuvants include but are not limited to the following: anise oil; ethyl 2-methylbutyrate; vanillin; cis-3-heptenol; cis-3-hexenol; trans-2-heptenal; butyl valerate; 2,3-diethylpyrazine; methyl cyclopentenolone; benzaldehyde; valerian oil; 3,4-dimethoxyphenol; amyl acetate; amyl cinnamate; gamma-butyrolactone; furfural; trimethylpyrazine; phenylacetic acid; isovaleraldehyde; ethyl maltol; ethyl vanillin; ethyl valerate; ethyl butyrate; cocoa extract; coffee extract; peppermint oil; spearmint oil; clove oil; anethole; cardamom oil; wintergreen oil; cinnamic aldehyde; ethyl 2-methylvalerate; gamma-hexenyl lactone; 2,4-heptadienal; methyl thiazole alcohol(4-methyl-5-.beta.-hydroxyethyl thiazole); 2-methylbutanethiol; 4-mercaptobutan-2-one; 3-mercaptopentan-2-one; 1-mercapto-2-propene; benzaldehyde; furfural; furfuryl alcohol; 2-mercaptopropionic acid; alkyl pyrazine; methylpyrazine; 2-ethyl-3-methylpyrazine; tetramethylpyrazine; polysulfides; dipropyl disulfide; benzyl methyl disulfide; alkyl thiophene; 2,3-dimethylthiophene; 5-methylfurfural; 2-acetylfuran; 2,4-decadienal; guiacol; phenylacetaldehyde; beta-decalactone; d-limonene; acetoin; amyl acetate; maltol; ethyl butyrate; levulinic acid; piperonal; ethyl acetate; octanal; valeraldehyde; hexanal; diacetyl; monosodium gulatamate; monopotassium glutamate; sulfur-containing amino acids, e.g., cysteine; hydrolyzed vegetable protein; 2-methylfuran-3-thiol; 2-methyldihydrofuran-3-thiol; 2,5-dimethylfuran-3-thiol; hydrolyzed fish protein; tetramethylpyrazine; propyl propenyl disulfide; propyl propenyl trisulfide; diallyl disulfide; diallyl trisulfide; dipropenyl disulfide; dipropenyl trisulfide; 4-methyl-2-[(methylthio)-ethyl]-1,3-dithiolane; 4,5-dimethyl-2-(methylthiomethyl)-1,3-dithiolane; and 4-methyl-2-(methylthiomethyl)-1,3-dithiolane. These and other flavor ingredients are provided in U.S. Pat. Nos. 6,110,520 and 6,333,180 hereby incorporated by reference.

Structures I and II or compositions incorporating them, as mentioned above, can be combined with one or more vehicles or carriers for adding them to the particular product. Vehicles can be edible or otherwise suitable materials such as ethyl alcohol, propylene glycol, water and the like, as described supra. Carriers include materials such as gum arabic, carrageenan, xanthan gum, guar gum and the like.

Structures I and II prepared according to our invention can be incorporated with the carriers by conventional means such as spray-drying, drum-drying and the like. Such carriers can also include materials for coacervating the thiazoline compounds of our invention to provide encapsulated products, as set forth supra. When the carrier is an emulsion, the flavoring composition can also contain emulsifiers such as mono- and diglycerides or fatty acids and the like. With these carriers or vehicles, the desired physical form of the compositions can be prepared.

The quantity of Structures I and II utilized should be sufficient to impart the desired flavor characteristic to the product. The quantity used will vary depending upon the ultimate foodstuff; the amount and type of flavor initially present in the foodstuff; the further processing or treatment steps to which the foodstuff will be subjected; the regional and other preference factors; the type of storage, if any, to which the product will be subjected; and the preconsumption treatment such as baking, frying and so on, given to the product by the ultimate consumer.

The preferred dosage range of the compounds according to the invention in product is from 0.001 ppm to 10 ppm, preferably 0.001 ppm to 5 ppm, more preferably 0.001 ppm to 1 ppm. Thus, a flavor composition may contain one or more compounds according to the invention.

Accordingly, the terminology “effective amount” and “sufficient amount” is understood in the context of the present invention to be a quantitatively adequate amount to alter the flavor of the foodstuff.

The following are provided as specific embodiments of the present invention. Other modifications of this invention will be readily apparent to those skilled in the art, without departing from the scope of this invention. As used herein, both specification and following examples all percentages are weight percent unless noted to the contrary. IFF as used in the examples is understood to mean International Flavors & Fragrances Inc.

### Example I

### Preparation of 1-Mercapto-2-propanone

Chloroacetone (250 gm, 2.70 mol) was added to a solution of a stirring Sodium Hydrosulfide Hydrate (303.0 gm, 5.40 mol), Water (300 ml) and Ethanol (300 ml) at 10° C. for an hour. Once feed was complete, the reaction mixture was stirred for 15 minutes prior to workup. The reaction mixture was quenched with water (250 ml) and extracted with diethyl ether (250 ml). The organic layer was washed with water followed by brine.

The crude containing the solvent was used as is for the next step.

### Preparation of 2-Ethyl -4-Methyl-3-Thiazoline

Ammonium Hydroxide (30 wt %, 630.9 g, 5.40 mol) was slowly added to a solution of propionaldehyde (188 g, 3.24 mol) in THF 9500 ml), while maintaining temperature at 20° C. Once complete, the reaction mixture was stirred for 15 minutes. Crude mercapto-2-propanone in ether was added dropwise to the reaction mixture. Once the feed was complete, the reaction mixture was stirred for 15 minutes prior to workup. The biphasic mixture separated and the aqueous extracted with diethyl ether. The organic layers were then combined and washed with brine. The crude solution was concentrated in vacuum and purified by fractional distillation under reduced pressure to yield a pale yellow oil (129 g, 37 mol % yield).

### Example II

Threshold of Structure I in water is 1 ppb and possesses tropical fruit, catty, peach and berry flavor notes.

### Structure I, 2-Ethyl -4-Methyl-3-Thiazoline, in Oatmeal

Commercially available plain instant oatmeal which ingredients are whole grain rolled oats, calcium carbonate, salt, guar gum, caramel color, reduced iron, niacinamide, vitamin A, palmitate, pyridoxine, hydrochloride, riboflavin, thiamin mononitrate and folic acid. At a dosage of 5 ppb the compound added a sulfurous, peach flavor.

At a dosage of 1 ppb the compound added faint sulfurous notes and synergized with grain notes.

### Structure I, 2-Ethyl -4-Methyl-3-Thiazoline, in Orange Soda

Carbonated water, high fructose corn syrup, citric acid, potassium benzoate, gum acacia, natural flavor, ester gum, yellow 6, brominated vegetable oil, red 40.

At a dosage of 5 ppb, the compound made the orange soda taste more like tangerine soda. It made the soda drink more natural tasting and cut acidity.

### Structure I, 2-Ethyl -4-Methyl-3-Thiazoline, in Beef Broth

Beef broth and less than 1% of the following: salt, MSG, hydrolyzed corn protein, hydrolyzed soy protein, hydrolyzed wheat protein, dextrose, onion powder, autolyzed yeast extract, caramel color, partially hydrogenated soybean oil, natural flavor, thiamine hydrochloride, disodium inosinate, disodium guanylate.

At a dosage of 4 ppb the compound boosted roasted notes. At a level above 4 ppb the thiazoline compounds imparted tropical notes.

### Structure I, 2-Ethyl -4-Methyl-3-Thiazoline, in Mixed Berry Yogurt

Cultured pasteurized grade A nonfat milk, high fructose corn syrup, modified corn starch, nonfat milk, kosher gelatin, corn starch, tricalcium phosphate, natural flavor, potassium sorbate added to maintain freshness, sucralose (splenda brand,) acesulfame potassium, colored with annatto extract, vitamin A acetate, vitamin D3.

At a dosage of 5 ppb the compound boosted fruity notes. At a level above 5 ppb the thiazoline compounds imparted peach notes.

What is claimed is:

1. A method for improving, enhancing or modifying a foodstuff comprising adding an effective amount of a compound of the following formula: 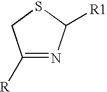
wherein R and R1 may be selected from hydrogen or a C₁ to C₅ alkyl group.

2. The method of claim 1 wherein R is a methyl and R1 is ethyl.

3. The method of claim 1 wherein R is ethyl and R1 is methyl.

4. The method of claim 1 wherein the compound is incorporated into a foodstuff selected from the group consisting of meats, sauces, gravies, soups, convenience foods, malt beverages, alcoholic beverages, soy-containing products, milk products, dairy products, herbs, fish, crustaceans, mollusks, candies, vegetables, cereals, soft drinks, snacks, dog food, cat foods and mixtures thereof.

5. The method of claim 4 wherein the foodstuff is a meat.

6. The method of claim 4 wherein the foodstuff is a soda.

7. The method of claim 4 wherein the foodstuff is a yogurt.

8. The method of claim 1 wherein the compound is present at a level from about 0.001 ppm to about 10 ppm by weight.

9. The method of claim 1 wherein the compound is present at a level from about 0.001 ppm to about 5 ppm by weight.

10. The method of claim 1 wherein the compound is present at a level from about 0.001 ppm to about 1 ppm by weight.
